(19) United States
(12) Patent Application Publication
(10) Pub. No.: US 2024/0416339 A1
(43) Pub. Date: Dec. 19, 2024

(54) ANALYSIS DEVICE

(71) Applicant: CANON KABUSHIKI KAISHA, Tokyo (JP)

(72) Inventors: JUN MIURA, Kanagawa (JP); MAKOTO FUKATSU, Shizuoka (JP); TAKESHI YAMAMOTO, Kanagawa (JP); MASANORI TANAKA, Kanagawa (JP); HARUNOBU MAEDA, Tokyo (JP); FUKA ENOKIDO, Kanagawa (JP); KEIJI MIYAZAKI, Tokyo (JP)

(21) Appl. No.: 18/676,693

(22) Filed: May 29, 2024

(30) Foreign Application Priority Data
Jun. 14, 2023 (JP) 2023-097579

(51) Int. Cl. B01L 3/00

(52) U.S. Cl. CPC B01L 3/502715; B01L 2300/0645; B01L 2300/0816; B01L 2300/0858; B01L 2300/165

(57) ABSTRACT

Due to a relationship between a channel wall and an electrode with respect to a porous substrate, it has been difficult to achieve both adhesiveness between the electrode and the substrate and suppression of electrode cracks caused by deformation of the substrate in a high-humidity environment or the like, and an inability to achieve both may inhibit ion concentration measurement from being correctly performed in some cases. Provided is a configuration in which the electrode has at least a part formed inside the porous substrate in an electrode portion that achieves contact with an external measuring instrument and the channel wall is always present on a straight line on which the electrode is present.

### BACKGROUND OF THE INVENTION

### Field of the Invention

The present invention relates to an analysis device in which an electrode is formed through use of a channel of a porous substrate.

### Description of the Related Art

In recent years, development of a microanalysis chip that enables analysis in biochemistry to be performed efficiently (in a trace amount, quickly, and easily) in one chip through use of a micro-sized microchannel has been attracting attention in a wide variety of fields. The wide variety of fields include not only research in biochemistry but also medical care, drug discovery, healthcare, environment, and food products. Of those, a paper microanalysis chip that is based on paper is more advantageous over related-art devices in terms of light weight, low cost, no power supply required, and high disposability. Thus, paper microanalysis chips are expected to serve as testing devices to be used, for example: for medical activities in a developing country, a remote region, and a disaster site in which medical equipment is not ready; and in an airport in which spread of an infectious disease is required to be halted at a border. In addition, due to inexpensiveness and ease of handling, paper microanalysis chips have been attracting attention as healthcare devices that enable individuals to manage and monitor their own health conditions.

As an example of the paper microanalysis chips, in U.S. Patent Application Publication No. 2016/033438, there is described a configuration in which an electrode is formed on a porous substrate so as to straddle a hydrophobic channel wall made of wax. In this configuration, one end of an electrode reacts with a specimen in a channel to form a predetermined potential, and a measuring instrument is connected to another electrode end to perform measurement. The configuration is formed of two electrodes, namely, a reference electrode indicating a fixed potential of a reference solution and an ion-selective electrode indicating a potential corresponding to an ion concentration of the specimen, and a potential difference between the two electrodes is measured, to thereby be able to measure an ion concentration of the specimen.

Further, in Analytical Chemistry 89, pp. 10,608-10,616, 2017, there is described an analysis chip capable of measuring an ion concentration of a specimen by measuring a potential difference between two electrodes, but in the configuration of this document, an electrode serving as a contact portion of a measuring instrument is formed on a hydrophobic channel wall made of wax.

However, in the method as described in U.S. Patent Application Publication No. 2016/033438, for example, when the analysis chip is placed in a high-humidity environment, there is a fear of deformation due to moisture absorption of paper and a crack occurring in the electrode. When a crack occurs in the electrode, a measured value of the potential is naturally affected, and hence it becomes difficult to correctly measure the ion concentration.

Further, in the method as described in Analytical Chemistry 89, pp. 10,608-10,616, 2017, the electrode serving as the contact portion of the measuring instrument is formed on a channel wall, and hence adhesiveness may deteriorate compared to a case of being formed on a porous material. When the adhesiveness of the electrode is poor, there is a fear that the electrode may peel off due to pressing, friction, or the like for achieving measurement contact, and when the electrode peels off, a measured value of the potential is naturally affected, and hence it becomes difficult to correctly measure the ion concentration.

### SUMMARY OF THE INVENTION

There is provided an analysis device including: a porous substrate; a channel wall formed by filling pores of the porous substrate with a hydrophobic material; and an electrode, wherein the analysis device includes a first region and a second region separated from each other by the channel wall, wherein the electrode is formed so as to straddle the first region, the channel wall, and the second region, wherein a straight line passing through the electrode always intersects the channel wall when the analysis device is viewed from above, and wherein the electrode further has at least a part formed inside the porous substrate in the second region.

Further features of the present invention will become apparent from the following description of exemplary embodiments with reference to the attached drawings.

### BRIEF DESCRIPTION OF THE DRAWINGS

FIG. 1 is a top view of an analysis device (M1) according to a first embodiment exhibited after formation of a channel wall (11) (before formation of an electrode).

FIG. 2A is a top view of a working electrode side of the analysis device (M1) according to the first embodiment.

FIG. 2B is a cross-sectional view of the analysis device (M1) according to the first embodiment taken along a broken line (D1).

FIG. 3A is a top view of the analysis device (M1) according to the first embodiment exhibited after various electrodes are formed.

FIG. 3B is a cross-sectional view of the analysis device (M1) according to the first embodiment taken along a broken line (D2).

FIG. 4A is a top view of an analysis device (M2) according to Comparative Example 1 exhibited after various electrodes are formed.

FIG. 4B is a perspective view of the analysis device (M2) according to Comparative Example 1 exhibited after various electrodes are formed.

FIG. 5 is a graph for showing results of measuring potentials of a chip in which a crack has occurred and a chip in which a crack has not occurred.

FIG. 6A a top view of an analysis device (M3) according to Comparative Example 2.

FIG. 6B is a cross-sectional view of the analysis device (M3) according to Comparative Example 2 taken along a broken line (D6).

### DESCRIPTION OF THE EMBODIMENTS

An exemplary embodiment of the present invention is described below with reference to the drawings. The following embodiment is illustrative, and the present invention is not limited to the contents of the embodiment. In addition, in the following respective drawings, constituents that are not required for the description of the embodiment are omitted from the drawings.

According to the embodiment of the present invention, there is provided an analysis device including: a porous substrate; a channel wall formed by filling pores of the porous substrate with a hydrophobic material; and an electrode, wherein the analysis device includes a first region and a second region separated from each other by the channel wall, wherein the electrode is formed so as to straddle the first region, the channel wall, and the second region, wherein a straight line passing through the electrode always intersects the channel wall when the analysis device is viewed from above, and wherein the electrode further has at least a part formed inside the porous substrate in the second region.

The first region may be a region that is permeated by a specimen. The second region may be a region for connection to an external measuring instrument, and the analysis device may be connected to the external measuring instrument through a portion of the electrode that is present in the second region. The analysis device may include a first electrode and a second electrode as the electrode, and the first electrode may be a reference electrode and the second electrode may be a working electrode.

### First Embodiment

### <Substrate and Channel>

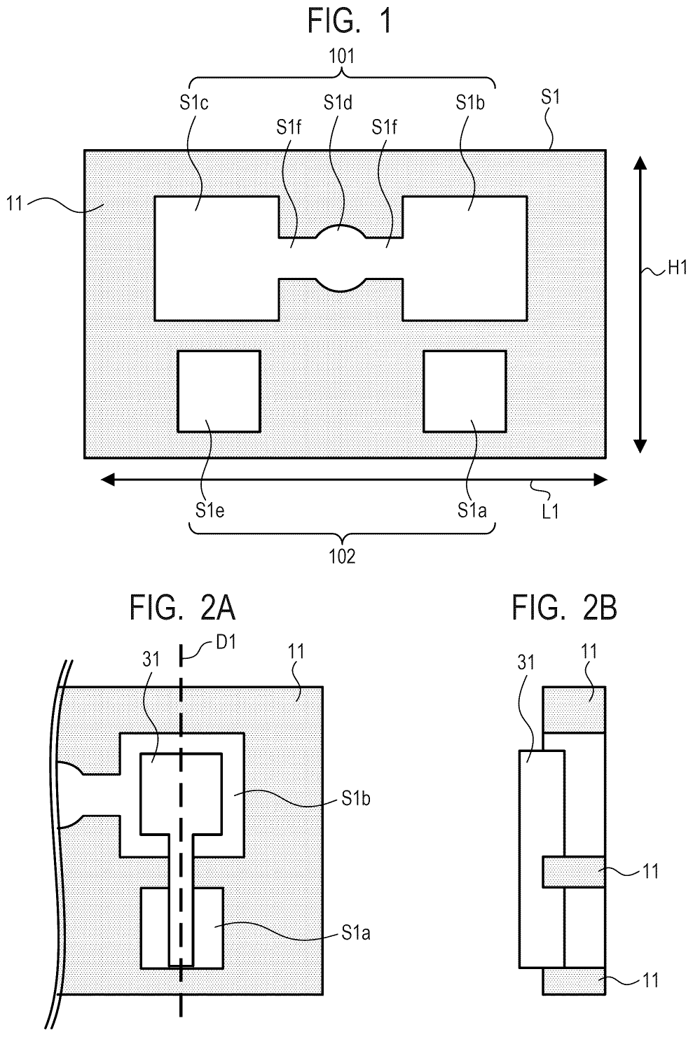

A substrate of an analysis device M1 is described with reference to FIG. 1. FIG. 1 is a simplified top view of the analysis device M1 exhibited before various electrodes are formed.

In this embodiment, filter paper was used as a porous substrate S1. A material of the used filter paper was cellulose and had a thickness of 100 μm and a porosity of 50%. Such filter paper has satisfactory hydrophilicity due to a capillary action caused by microvoids between cellulose fibers, and functions as a channel that is smoothly permeated by a liquid. It should be understood that the porous substrate S1 is not limited to a filter paper as long as the porous substrate S1 functions as a channel, and examples thereof may include not only paper such as plain paper, fine paper, watercolor paper, Kent paper, and synthetic paper but also a synthetic resin porous film, a fabric, and a fibrous product. The porosity can be appropriately selected depending on a purpose, and is preferred to be a porosity of between 20% to 90% inclusive. When the porosity exceeds 90%, it may not be possible to maintain a strength of the substrate, and when the porosity is less than 20%, permeability of a sample solution may deteriorate.

The porosity (%) is calculated by “porosity (%)=((true density)−(apparent density))/(true density)×100.”

As a hydrophobic material, a hydrophobic resin was caused to permeate a partial region of the porous substrate S1, to thereby form a channel wall 11 having a vertical width H1 of 14 mm and a horizontal width L1 of 22 mm. The channel wall 11 was formed by a method as described in Japanese Patent Application Laid-Open No. 2021-37612, in which electrophotographic printing using a hydrophobic resin as a toner is performed and the resin was melted and caused to permeate by heating. As the hydrophobic material for forming the channel wall, a hydrophobic resin is preferred. The hydrophobic resin is not particularly limited, and there are used, for example, a polyester resin, a vinyl-based resin, an acrylic resin, a styrene acrylic resin, polyethylene, polypropylene, polyolefin, an ethylene-vinyl acetate copolymer resin, and an ethylene-acrylic acid copolymer resin. Examples of a method of arranging a hydrophobic resin may include not only a method involving use of an electrophotographic apparatus but also a method involving use of an ink-jet printer, a method of causing a wax to permeate by a wax printer, and a method of causing a resin to permeate by screen printing. Further, a plurality of methods may be used in combination to form a hydrophobic resin.

In an inner region of the channel wall 11, there are regions that are not permeated by a hydrophobic resin to form a channel wall, that is, regions that do not have channel walls. The analysis device according to this embodiment includes at least a first region 101 and a second region 102 as the regions that do not have channel walls. The first region 101 is a region that is permeated by a specimen due to a capillary action caused by porosity of the porous substrate S1. In this embodiment, the first region 101 is formed of a working electrode placement portion S1b in which a working electrode is placed, a reference electrode placement portion S1c for placing a reference electrode, a dispensing portion S1d positioned between the working electrode placement portion S1b and the reference electrode placement portion S1c, and channels S1f, each of which has a width of 2 mm, and through which the dispensing portion S1d communicates with the working electrode placement portion S1b and the reference electrode placement portion S1c. However, the first region 101 is not always required to include all thereof, and may include other portions and channels. In this embodiment, the working electrode placement portion S1b and the reference electrode placement portion S1c are each a square with sides of 6 mm, and the dispensing portion S1d is a circle having a diameter of 3 mm. A size, a shape, and the like of each of the placement portions and the channels are not limited to those. Next, of the regions that do not have channel walls, the second region 102 is a region that is a place in which contact with an external measuring instrument is achieved at a time of measurement, and the second region 102 is not always permeated by a specimen. In this embodiment, the second region 102 includes a working electrode contact portion Sla and a reference electrode contact portion S1e, and each contact portion is a square with sides of 4 mm. In this embodiment, an example in which the working electrode contact portion Sla and the reference electrode contact portion S1e are separated from each other by the channel wall and do not communicate with each other is described, but the working electrode contact portion Sla and the reference electrode contact portion S1e may communicate with each other. Meanwhile, the first region 101 and the second region 102 do not communicate with each other and are formed so as to be separated from each other by the channel wall 11. Details of the contact are described later together with description of the electrode.

Now, formation of a working electrode of the analysis device M1 is described with reference to FIG. 2A and FIG. 2B.

FIG. 2A is a top view of the analysis device M1 exhibited after a working electrode 31 was formed, and a cross-section thereof taken along a broken line D1 is illustrated in FIG. 2B.

### <Working Electrode>

The working electrode 31 is an electrode having a shape in which a square with sides of 4 mm that fits in the working electrode placement portion S1b and a rectangle having a width of 1 mm and a length of 6 mm and extending from the working electrode placement portion S1b to the working electrode contact portion Sla are continuous. As a material of the working electrode 31, Ag was used as an electrode that detects an ion concentration of Cl⁻, but the material is not limited thereto, and any material or configuration that functions as a working electrode is sufficient. The working electrode 31 may also form an ion-selective membrane in addition to the electrode.

The working electrode 31 was formed through use of a screen printer DP-320 manufactured by NEWLONG SEIMITSU KOGYO Co., LTD. A plate of #200 was used to perform printing, and drying was performed at 80° C. for 10 minutes. However, a method of forming the working electrode 31 is not limited thereto. As the electrode, an electrode using carbon or the like is used, in addition to Ag/AgCl and PEDOT/PSS, without any particular limitation. For a method of producing an electrode through use of Ag/AgCl or carbon, it is possible to refer to, for example, U.S. Patent Application Publication No. 2016/033438. For a method of producing an electrode through use of PEDOT (poly(3,4-ethylenedioxythiophene))/PSS (poly(4-styrenesulfonate)), it is possible to refer to, for example, Analytical Chemistry 89, pp. 10,608-10,616, 2017.

In a case of the working electrode 31 having an ion-selective membrane, the ion-selective membrane may be any membrane that is generally used, and may be any selective membrane that is sensitive to ions of interest and has sufficient selectivity to interfering ions. The ion-selective membrane includes a compound having ion selectivity. The compound having ion selectivity is not particularly limited, and preferred examples thereof can include an ionophore and an anion eliminator that exhibit ion selectivity. Examples of the ionophore include 12-crown 4-ether having a crown ether structure, and examples of the anion eliminator include sodium tetraphenylborate (NaTPB). Any publicly known material that is used for the ion-selective membrane can be used, and as such a material, it is possible to refer to, for example, page 138 to page 140 of “How to Measure Ion Concentration with Electrodes” by DOJINDO LABORATORIES.

The ion-selective membrane can also include a polymer compound in order to maintain a structure thereof. Examples of the polymer compound include polyvinyl chloride (abbreviation: PVC) and a copolymer of vinyl chloride and vinyl acetate. The ion-selective membrane can also include a plasticizer in order to enable the ionophore to operate. A publicly known plasticizer is applicable, and a lipophilic ion-exchange material that is a material acting as a lipophilic ion-exchanger in the ion-selective membrane is more preferred. Examples of the publicly known material include 2-nitrophenyl octyl ether (abbreviation: NPOE), bis(2-ethylhexyl) sebacate (abbreviation: DOS), bis(2-ethylhexyl) adipate (abbreviation: DOA), and di-n-octylphenyl phosphonate (abbreviation: DOPP).

As illustrated in FIG. 2B, the working electrode 31 formed in the above-mentioned manner has parts formed inside the porous substrate in the first region 101 and the second region 102. That is, in the working electrode placement portion S1b, which is the first region 101, and the working electrode contact portion Sla, which is the second region 102, parts of the electrode permeate pores of the porous substrate S1, and an electrode is formed also inside the porous substrate S1. Thus, not only contact with a specimen is appropriately performed in the working electrode placement portion S1b, which is the first region 101, but also adhesiveness between the electrode and the porous substrate S1 can be enhanced due to an anchor effect in the working electrode contact portion Sla, which is the second region 102. Accordingly, the working electrode contact portion Sla, which is the second region 102, is set as the contact portion with the external measuring instrument, to thereby be able to form an electrode that is less likely to peel off even when the electrode is subjected to pressing and friction due to the measurement contact. In order to obtain this effect, a porous substrate is required to be exposed in at least a part of a surface of the second region 102.

In this embodiment, both the working electrode contact portion Sla and the reference electrode contact portion S1e, which form the second region 102, have a configuration in which nothing is included inside the porous substrate S1. However, a desired material may be placed in the porous substrate in those contact portions for the purpose of physical property adjustment of the substrate or the like as long as at least a part of the porous substrate is exposed in the surface. For example, in order to enhance rigidity of the working electrode contact portion Sla, a predetermined resin may be impregnated in the porous material, to thereby be able to improve ease of achieving contact with the external measuring instrument. A type, a shape, and an amount of the material to be used for formation in the porous substrate S1 at that time are freely selectable within a range in which the pores of the porous substrate S1 are exposed in the surface.

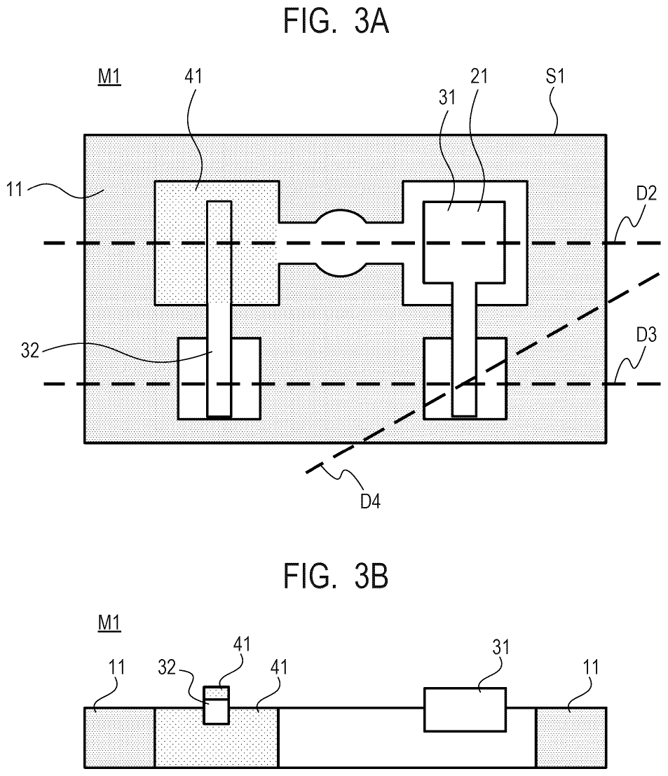

Now, formation of a reference electrode of the analysis device M1 is described with reference to FIG. 3A and FIG. 3B.

FIG. 3A is a top view of the analysis device M1 exhibited after the working electrode 31 was formed, and a cross-section thereof taken along a broken line D2 is illustrated in FIG. 3B.

### <Reference Electrode>

A reference electrode 32 is formed so as to straddle from the reference electrode placement portion S1c, which is the first region 101, to the reference electrode contact portion S1e, which is the second region 102, and has a rectangular shape of (1 mm)× (10 mm). The reference electrode 32 reacts with a specimen that has permeated the channel in the reference electrode placement portion S1c, which is the first region 101 in the same manner as in a case of the working electrode 31, and is capable of achieving contact with the external measuring instrument in the reference electrode contact portion S1e, which is the second region 102. With as small a width as 1 mm, when an electrolyte layer 41 described later is applied, the electrolyte layer 41 is easily placed on the porous substrate in the reference electrode placement portion S1c including a back side of the reference electrode 32.

As a material of the reference electrode 32, Ag/AgCl was used. Through use of Ag/AgCl, an equilibrium reaction in accordance with Formula (1) occurs in an aqueous solution, and hence a stable potential can be obtained in a state in which the Cl⁻ concentration around the reference electrode 32 is stable.

Ag+Cl⁻ [symbol] AgCl+e⁻ Formula (1)

The reference electrode 32 was applied to the reference electrode placement portion S1c through use of a screen printer DP-320 manufactured by NEWLONG SEIMITSU KOGYO Co., LTD. A plate of #200 was used to perform printing, and drying was performed at 80° C. for 10 minutes. However, a method of producing an electrode is not limited thereto, and any kind of method is used as described in the section of the working electrode.

In the reference electrode contact portion S1e, which is the second region, the reference electrode 32 has a part formed inside the porous substrate S1 in the same manner as in a case of the working electrode contact portion Sla. Thus, the reference electrode 32 is less likely to peel off.

### <Electrolyte Layer>

The electrolyte layer 41 dissolves with moisture of a specimen when the specimen introduced into the dispensing portion S1d has permeated the reference electrode placement portion S1c, and sets Cl⁻ to a saturation concentration. When Cl-becomes the saturation concentration, a potential of the reference electrode 32 is stabilized. Thus, in this embodiment, KCl was used as a material of the electrolyte layer 41. KCl easily dissolves in water, and diffusion rates of K ions and Cl ions are substantially equal to each other with a lower probability of causing a liquid junction potential, based on which KCl was selected. It should be understood that the material of the electrolyte layer 41 is not limited thereto, and any material, for example, NaCl or the like may be used as long as the potential of the reference electrode 32 can be stabilized.

The electrolyte layer 41 was applied through use of a BioSpot manufactured by MICROJET Co., Ltd. A solution was prepared by dissolving KCl in pure water to a concentration of 16% by mass. Printing was performed over an entire area of the reference electrode placement portion S1c at a liquid droplet size of 6 nL/droplet, a frequency of 10 Hz, and a pitch of 300 μm in both length and width, and overlay coating was performed three times, to thereby adjust an amount of KCl. The amount of KCl is set to an amount that becomes saturated with respect to an amount of a specimen that permeates the reference electrode placement portion S1c, to thereby be able to stabilize the potential of the reference electrode 32. Thus, an amount of the application is not limited thereto as long as the amount of contained KCl is sufficient to saturate KCl. An aqueous KCl solution has a lower viscosity than a solution of an ion-selective membrane 21, and with the droplet size being increased and the frequency being increased, diffuses in the porous substrate S1 before the aqueous KCl solution adhering to the porous substrate S1 volatilizes, to thereby be able to place KCl also on the back side of the reference electrode 32 as illustrated in FIG. 3B. Accordingly, when the specimen has permeated, the Cl-concentration around the reference electrode 32 becomes stable, thereby stabilizing the potential of the reference electrode 32. That is, the reference electrode 32 functions as a reference electrode with more stability.

In the analysis device M1, a straight line passing through an electrode always passes through the channel wall as well. For example, in a broken line D3 of FIG. 3A, a channel wall 11 is formed in places other than the working electrode contact portion Sla and the reference electrode contact portion S1e. In the same manner, a broken line D4, which is taken with a changed angle, is configured to pass through the channel wall as well as through the electrode. With this configuration, the porous substrate S1 is prevented from being deformed even at a time of being placed in a high-humidity environment, and a crack in the electrode can be suppressed.

### Comparative Example 1

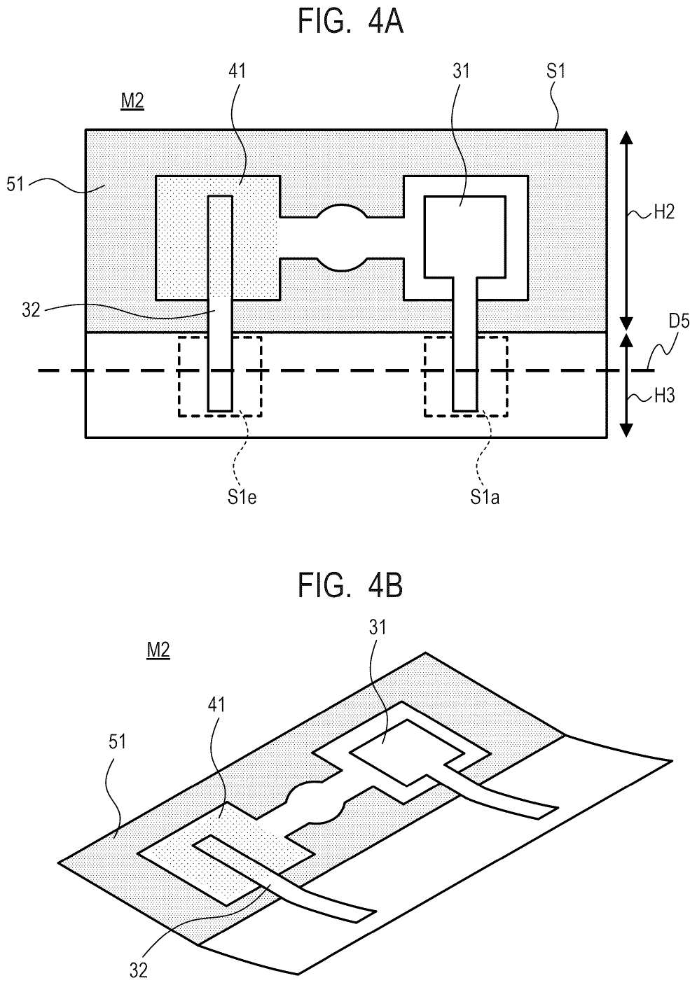

An analysis device M2 according to Comparative Example 1 with respect to the analysis device M1 is described with reference to FIG. 4A and FIG. 4B.

FIG. 4A is a simplified top view of the analysis device M2, and FIG. 4B is a simplified perspective view of the analysis device M2. A configuration of the analysis device M2 is the same as the configuration of the analysis device M1 except for the shape of the channel wall, and hence like components are denoted by like reference symbols, and description of the same parts is omitted.

As illustrated in FIG. 4A, a channel wall 51 of the analysis device M2 includes a hydrophobic channel wall in a range of a vertical width H2 of 7 mm only in an upper part of the analysis device M2 when viewed toward the drawing sheet. Meanwhile, the channel wall is not provided in a range indicated by H3 corresponding to the second region and the like of the analysis device M1, that is, in a range corresponding to a lower part of the analysis device M2 when viewed toward the drawing sheet. Thus, at a position of a broken line D5, the electrodes are present, but the channel wall is not present. That is, the analysis device M2 has a straight line passing through the electrodes without passing through the channel wall when the analysis device is viewed from above, and does not satisfy a condition that a straight line passing through an electrode always intersects the channel wall.

Now, a case in which the analysis device M2 is placed in a high-humidity environment is described.

In a high-humidity environment, water is adsorbed on the porous substrate S1 made of cellulose having high hydrophilicity, and hence fibers of the paper swell, thereby causing waviness in the porous substrate S1 and deformation thereof. FIG. 4B shows a state in which, due to an influence of the deformation of the porous substrate S1, the working electrode 31 and the reference electrode 32 that are formed thereon are also deformed. When such deformation occurs, the electrodes cannot withstand a stress of the deformation, thereby causing a crack therein, and at a time of performing potential measurement by the external measuring instrument, an increase in load resistance and a failure in electrical continuity due to the crack may inhibition concentration measurement from being correctly performed.

At this time, in a place in which the channel wall 51 is present, adsorption of water does not occur due to hydrophobicity of the channel wall 51, and deformation due to swelling of the porous substrate S1 or the like does not occur. Further, the presence of the channel wall 51 increases rigidity as compared to a case of only the porous substrate S1, and hence a channel surrounded by the channel wall 51 is prevented from being deformed. That is, the deformation of the porous substrate S1 may be caused by swelling or the like due to moisture adsorption on a straight line involving no channel wall, such as in the broken line D5, and when an electrode exists at the deformation, measurement may not be correctly performed due to a crack in the electrode.

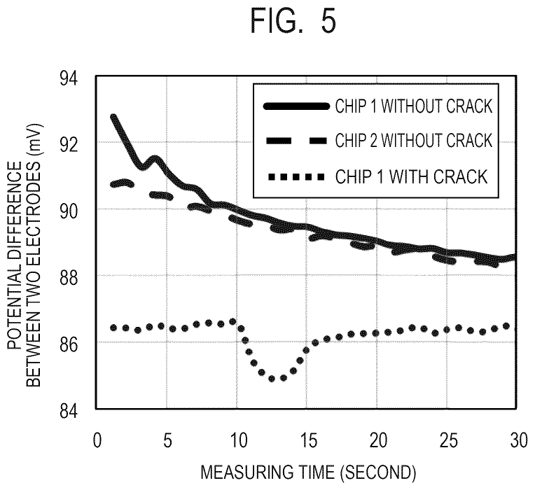

FIG. 5 shows a potential difference between the working electrode and the reference electrode exhibited when a specimen prepared by dissolving 100 mM of NaCl was actually dispensed into the dispensing portion S1d of the analysis device M2. For potential measurement, a potential difference between the working electrode contact portion Sla and the reference electrode contact portion S1e was measured through use of VSP-300 manufactured by Bio-Logic. The analysis device used for the measurement is a total of three chips (analysis devices), namely, two chips (chips 1 and 2 without a crack) in which no crack has occurred in the electrodes and one chip (chip 1 with a crack) in which a crack has occurred. As shown in FIG. 5, it is understood that a chip in which no crack has occurred exhibits almost the same potential after, for example, 10 seconds, but a chip in which a crack has occurred differs greatly in potential, and an ion concentration of the specimen cannot be measured correctly even when an attempt is made to measure the ion concentration.

### Comparative Example 2

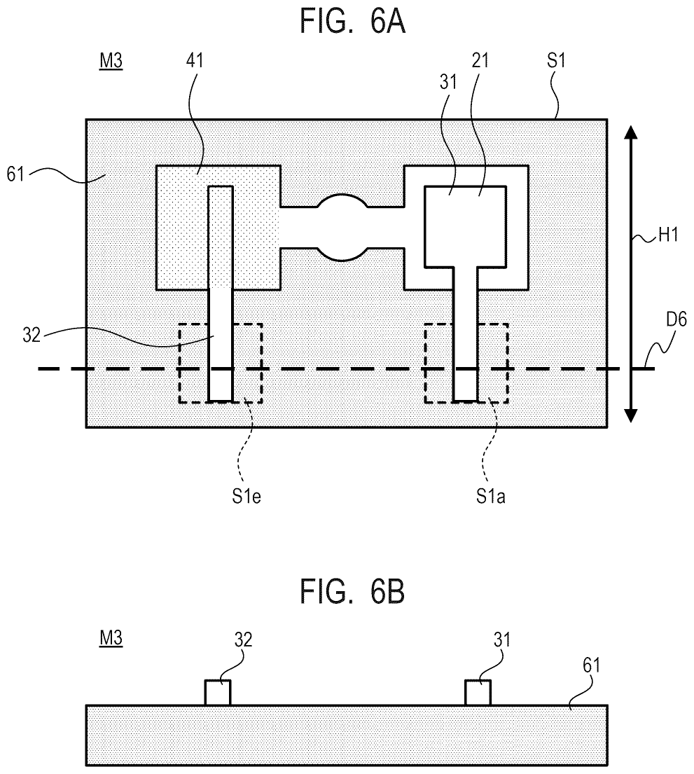

Next, an analysis device M3 according to Comparative Example 2 with respect to the analysis device M1 is described with reference to FIG. 6A and FIG. 6B.

FIG. 6A is a simplified top view of the analysis device M3, and a cross-section thereof taken along a broken line D6 is illustrated in FIG. 6B. A configuration of the analysis device M3 is the same as the configuration of the analysis device M1 except for the shape of the channel wall, and hence like components are denoted by like reference symbols, and description of the same parts is omitted.

As illustrated in FIG. 6A, the analysis device M3 includes a channel wall 61 having a vertical width H1 of 14 mm in the same manner as the analysis device M1, but also has the channel wall 61 formed in the working electrode contact portion Sla and the reference electrode contact portion S1e. That is, the analysis device M3 does not include the second region. With this configuration, unlike the analysis device M2 described above, the analysis device M3 is less likely to have the porous substrate S1 deformed even at the time of being placed in a high-humidity environment, and even a crack does not occur in the electrodes.

Meanwhile, as illustrated in FIG. 6B, the analysis device M3 does not include the second region, and naturally, the working electrode does not include a portion formed inside the porous substrate in the second region. In the working electrode contact portion Sla and the reference electrode contact portion S1e, the working electrode 31 and the reference electrode 32 are formed on an upper layer of the channel wall 61. That is, the pores of the porous substrate S1 are filled with the channel wall 61, and the electrodes are formed thereon. Accordingly, the above-mentioned anchor effect with respect to the substrate cannot be obtained for the working electrode 31 and the reference electrode 32, resulting in low adhesiveness. This causes the working electrode 31 and the reference electrode 32 to peel off from the porous substrate S1 when the pressing or friction caused by the measurement contact with the external measuring instrument is received at a time of potential measurement, and hence the potential measurement may not be stably performed in some cases.

Results of the above-mentioned embodiment and Comparative Examples are tabulated as follows.

TABLE 1

| | Substrate deformation | | Peeling of | |
|---|---|---|---|---|
| | in high-humidity | Occurrence of | electrode during | |
| | environment | electrode crack | measurement | Potential stability |
| Analysis device M1 (first embodiment) | Good Small deformation | Good Does not occur | Good Does not occur | Good Stable |
| Analysis device M2 (Comparative Example 1) | No good Large deformation | No good Occurs | Good Does not occur | No good Unstable |
| Analysis device M3 (Comparative Example 2) | Good Small deformation | Good Does not occur | No good Occurs | No good Unstable |

This embodiment has been described by taking a case in which the analysis device is placed in a high-humidity environment as an example in which the substrate is deformed. However, the situation is not limited thereto, and the same phenomenon occurs during a process of producing an analysis device in, for example, a case in which cleaning is performed after electrode formation and a case in which a solvent or the like permeates the porous substrate S1 in a pretreatment step. Accordingly, even in such cases, stable potential measurement can be performed with the configuration of this embodiment.

As described above, with a configuration in which an electrode formed so as to straddle the second region in which a porous material is exposed in a surface and the first region separated therefrom by the channel wall is provided and the channel wall is always present on a straight line in which the electrode is present, it is possible to enhance adhesiveness between the electrode and the substrate while suppressing a crack in the electrode due to the deformation of the substrate.

That is, with this configuration, it is possible to provide an analysis device capable of stably performing potential measurement.

That is, according to one embodiment of the present disclosure, it is possible to provide a microanalysis chip which has high adhesiveness between an electrode and a porous substrate while suppressing a crack in the electrode due to the deformation of the substrate, and which is capable of performing stable potential measurement.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-097579, filed Jun. 14, 2023, which is hereby incorporated by reference herein in its entirety.

What is claimed is:

1. An analysis device comprising:
a porous substrate;
a channel wall formed by filling pores of the porous substrate with a hydrophobic material; and
an electrode,
wherein the analysis device includes a first region and a second region separated from each other by the channel wall,
wherein the electrode is formed so as to straddle the first region, the channel wall, and the second region,
wherein a straight line passing through the electrode always intersects the channel wall when the analysis device is viewed from above, and
wherein the electrode further has at least a part formed inside the porous substrate in the second region.

2. The analysis device according to claim 1, wherein the first region comprises a region that is permeated by a specimen.

3. The analysis device according to claim 1,
wherein the second region comprises a region for connection, and
wherein the analysis device is connected to an external measuring instrument through a portion of the electrode that is present in the second region.

4. The analysis device according to claim 1,
wherein the electrode comprises a first electrode and a second electrode,
wherein the first electrode comprises a reference electrode, and
wherein the second electrode comprises a working electrode.
